(19) United States
(12) Patent Application Publication
(10) Pub. No.: US 2003/0168410 A1
(43) Pub. Date: Sep. 11, 2003

(54) System for removing organics from a wastewater stream

(76) Inventors: Michael R. Robicheaux, Breaux Bridge, LA (US); Jeffrey A. Grist, Youngsville, LA (US); Thomas L. Wilkerson, Lafayette, LA (US)

Correspondence Address: ONEBANE, BERNARD, TORIAN, DIAZ, MCNAMARA & ABELL, P. O. BOX 3507, LAFAYETTE, LA, 70502, US

(21) Appl. No.: 10/091,763

(22) Filed: Mar. 5, 2002

(51) Int. Cl. B01D 15/04

(52) U.S. Cl. 210/691

(57) ABSTRACT

System for enhanced removal of hydrocarbons from a fluid stream, especially one comprised predominantly of water, from a producing oil and gas well, from flowbacks from remediation treatments such as acid jobs, or from wastewater produced as a product of transmission pipeline operations. The fluid stream is flowed and/or pumped through a sequence of processing equipment, including a gas flotation unit in combination with a cellulose based filter media unit downstream of the flotation unit.

### BACKGROUND

1. Field of the Invention

In general, this invention relates to apparatus and method used to treat wastewater streams to remove undesirable components. More particularly, the invention comprises a system for the treatment of wastewater streams to remove entrained organics, typically hydrocarbons. In particular, but not exclusively, the system can be used to treat a produced water stream from an “oil” or “gas” well (referred to as “wells”); to treat fluid streams which are flowed out of wells after stimulation treatments, such as acid jobs, completions and “frac packs”; and to treat wastewater streams generated during certain pipeline operations, such as pigging, hydrotest or routine maintenance.

1. Related Art

In several different industrial applications, liquid streams are generated which are comprised mostly of water, but which have a certain fraction of organics or hydrocarbons entrained in the water stream. Such water streams are referred to in this application as “wastewater” streams. These entrained hydrocarbons remain even after gravity-type separation treatment.

Disposal of such wastewater is a problem. A common operational situation involves oil and gas production from offshore production facilities. Usually, the wastewater cannot be disposed of by simply dumping it into an available body of water, for example back into the ocean. The goal of wastewater treatment is to reduce the organic content in a wastewater stream to a sufficiently low level that governmental regulations regarding maximum organic concentrations are satisfied, and the wastewater can be simply dumped overboard.

Commonly, a wastewater stream is produced from wells, where the overall fluid stream flowing from the well is a mixture (of varying proportions) of oil, natural gas, and water. The gas phase is generally relatively easily separated from the liquid phase (comprising oil and water). While an initial separation of the oil and water may be readily accomplished by gravity separation, some oil remains entrained in the wastewater stream, and often the amount of entrained oil in the wastewater stream is too high for the water to be disposed of by dumping into the ocean, or, in the case of onshore pipelines, into a navigable waterway.

Yet another example of wastewater streams containing entrained hydrocarbons are the “flow-backs” from wells after stimulation work, such as acid treatments, recompletions and the like. Operators of wells often seek to enhance production rates by pumping quantities of acid into the producing formation. After this is done, the spent acid volume, along with the carrier fluid, spacer pill volumes, etc. must be flowed back out of the well before production is re-established. The so-called “flow-back” usually has a quantity of entrained liquid hydrocarbon that must be removed from the wastewater stream.

Yet other examples of wastewater streams containing entrained hydrocarbons include liquids from pipeline pigging operations and the like.

In addition to gravity-type separation, a number of different types of devices are used to remove organics, often in combination. Other hydrocarbon/water separation devices known as gas sparging or “flotation units” are used, generally downstream of the gravity separation equipment. Flotation units, generally, work on the principle of injecting a stream of extremely small gas bubbles (through a gas eductor or gas “sparger”) into the hydrocarbon/water stream, where the bubbles tend to attach to very small hydrocarbon droplets entrained within the water. The bubbles/droplets then tend to coalesce and rise to the surface of the water, where various means (such as skimming) are used to remove the resultant oil fraction from the surface of the water. In addition, certain types of filter media may be employed integral to the flotation unit.

Still further, filter media of different types have been employed downstream of the flotation cell. A filter press may be disposed in the wastewater stream. Absorption fabric or “sock” filters have long been used to remove not only organics but solids (such as sand and the like) from the wastewater stream. Next, adsorption media remove still more of the organic fraction. Usually as a final or near-final step, “polishing” media, often carbon-based, may be contained in vessels through which the wastewater stream is pumped.

Typically, the treatment equipment described above are used in series, that is, in sequence: 1) gravity separation; 2) flotation unit; 3) filter press; 4) sock filters; 5) adsorption media; and 6) polishing media. It is understood, however, that a different sequence of equipment use may be employed.

It has been found that a particular type of adsorption media, namely surface modified cellulose based media, may be effectively used in the treatment of organic-containing wastewater streams generated in well operations and pipeline operations. Surface modified cellulose-based media have the advantage of chemically bonding with the organic contaminants, such that the cellulose-based media hold a tremendous amount of hydrocarbons per unit of media weight, typically in excess of 200% of its own weight (that is, the weight of the media). While cellulose-based filter materials are known in the art to have been used to treat contaminated water emanating from industrial applications such as runoff from gas and oil facilities, bilge water from ships, surface water runoff, machine shops and auto repair shops and the like, and car washes, to the knowledge of applicants cellulose based media have not previously been used in combination with gas flotation units to treat wastewater streams from producing wells, flowbacks from such wells following stimulation, and from pipeline operations.

### SUMMARY OF THE INVENTION

The invention is a system for removing organics from a wastewater stream. The system comprises a gas sparging/flotation unit/coalescer in combination with a cellulose-based adsorptive filter media. Following primary separation such as by gravity, the wastewater stream is flowed or pumped through the flotation unit, then through the cellulose-based adsorptive filter media. Additional processing equipment may include a filter press and sock type filters disposed in the wastewater flow intermediate the flotation cell and the cellulose-based media (that is, upstream of the cellulose-based media), and “polishing” filter media downstream of the cellulose-based media.

### BRIEF DESCRIPTION OF THE DRAWINGS

FIG. 1 is a schematic of an exemplary system layout for treatment of wastewater streams flowed from oil and gas wells.

FIG. 2 is a is a schematic of an exemplary system layout for treatment of wastewater stream from transmission pipeline operations.

### DESCRIPTION OF THE PRESENTLY PREFERRED EMBODIMENT

While a number of different embodiments of the present invention are possible, with reference to the drawings one presently preferred embodiment is now described. It is understood that changes to the embodiment herein described may be made without departing from the spirit of the invention.

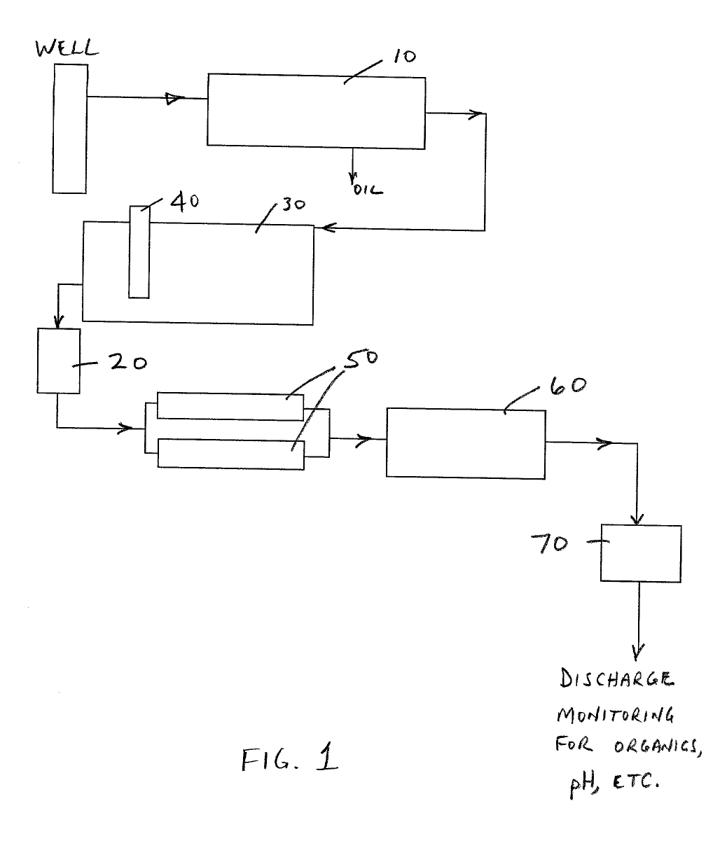

FIG. 1 shows a presently preferred embodiment of the invention for treatment of wastewater streams, in particular removal of organics from a wastewater stream generated as a result of well operations. While such wastewater stream may result from normal oil and/or natural gas production, by way of example the wastewater stream to be treated here is one from the flowback of a well, after a stimulation, such as an acid job or various completion operations.

An initial oil/water separation is done via conventional gravity separator 10. One or more gravity separators 10 may be used in parallel or series (that is, the water fraction from one such separator dumping into the next).

A gas sparging or flotation unit 30 preferably next receives the wastewater flowstream for further removal of entrained organics. As described earlier herein, the flotation unit 30 injects very small gas bubbles into the wastewater stream, which bond to the organic (oil) droplets, tend to coalesce together and rise to the surface where the resultant oil can be skimmed off or pass over one or more weirs to an oil leg. Flotation units are well known in the art, and while such units may take different embodiments, a representative flotation unit suitable for use in the present invention is disclosed in U.S. Pat. No. 4,800,025, the specification of which is incorporated herein by reference, for the purpose of setting forth a representative flotation unit. It is understood, however, that the scope of the instant invention is not limited to the flotation unit disclosed in U.S. Pat. No. 4,800,025, but instead that represents a unit generally suitable for use in a presently preferred embodiment. Flotation units of this nature typically comprise a plurality of gas eductors or gas spargers, which create and inject micro-bubbles into the fluid stream, where the bubbles cling to organic contaminants and float them to the surface of the wastewater stream; and various types of coalescers for aggregation of the organic contaminants.

Flotation unit 30 may preferably include a coalescing media 40 therein, for example one marketed under the trade name PETRO PAK™ available from McTighe Industries, Sioux Falls, S. Dak., U.S.A. This filtration device is a polypropylene matrix of oleophilic fibers, which attract very fine droplets of oil, coalesce them, where they then tend to rise to the surface of the wastewater stream for removal. The wastewater stream thus generated may next be routed to a separation device known as a filter press 20, which removes entrained solids (such as sand).

Sock filters 50, in the preferred embodiment, are disposed in the wastewater stream downstream of flotation unit 30. Such sock filters typically comprise a number of elongated, fiber filled, fabric coated tubes through which the water flows. The sock filters capture a certain portion of both entrained organics, coated solids, and solids such as sand and dirt. The sock filters remove most solids and oil wet solids carried in the wastewater flowstream, before the wastewater flows through the cellulose based filter media 60, extending the service life of the cellulose based filter media.

Cellulose based filter media 60 are disposed in the wastewater flowstream downstream of sock filters 50. Usually, the cellulose based filter media 60 are contained in a vessel or “pod” which holds a number of individual, elongated filters comprising the cellulose based material. Such cellulose based filter media, in particular but not exclusively in combination with flotation unit 30 and sock filters 50, when used to remove organics from wastewater streams from producing wells, well stimulation flowback streams, completion flowbacks, and wastewater streams from pipeline operations, are a key aspect of the present invention. Cellulose based filter media suitable for use in the present invention include the oil adsorbing cartridges model OAC-20BB, available from US Filter, Plymouth Products, Sheboygan, Wis., United States of America. Cellulose based filter media have the ability to adsorb a very high amount of organics per weight of cellulose based media, as high as 300% (that is, the cellulose based media may hold three times its own weight in organics). The small oil particles are attracted to the cellulose based media and cling to the fibers therein. The oil remains attached to the filters when removed from the filter holding unit. These cellulose based media further have the advantage of not plugging with organic particles, so that no significant pressure differential is created as the accumulation of organics increases. Cellulose based filter media are preferably replaced when the adsorbed organic weight is anywhere from 150% to 300% of the media weight, typically around 250% of the media weight. In the presently preferred embodiment, the need for replacement of the cellulose based media is determined by a combination of monitoring pressure differential of the flow through the cellulose based media, combined with sample analyzation of influent and effluent from the media. Typically, the cellulose based media are changed when a pressure differential of about 10 pounds per square inch is measured across the media. Sample monitoring of influent and effluent can also be used, and when effluent organic content is trending toward unacceptable levels, then media replacement is indicated.

Downstream of cellulose based filter media 60, the present invention, in one embodiment, may include further “polishing” media such as activated carbon filters/media 70. Final monitoring of the discharged, treated fluid will include measurement of organic contaminant level (“oil and grease” levels), pH, and other components.

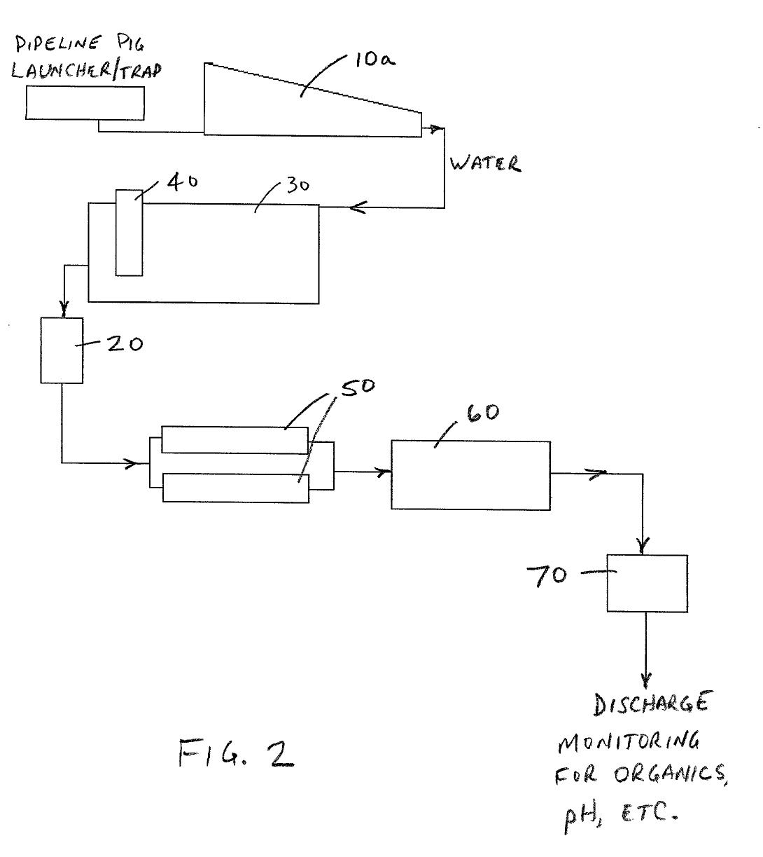

FIG. 2 sets forth a typical system arrangement in the processing of wastewater streams generated as a result of pipeline operations. Once such operation is the running of a pipeline “pig” through a section of pipeline, which is a generally plug-type apparatus having a diameter approaching the inner diameter of the pipeline. The pig is “launched” or introduced into the pipeline, then forced down a section of pipeline by fluid pressure, to a “trap” where the pig is removed from the pipeline flowstream. The purpose of this so-called pigging operation is to remove solids, liquids and the like which may have built up in the line. Liquids which may be pushed ahead of the pig are forced to the pig trap, and from there typically to a gravity separation device 10a, which may be a large settling tank. From the discharge of gravity separation device 10a onward, the flowpath of the wastewater follows the same sequence through the same equipment as described above with reference to FIG. 1, with like element numbers referring to like equipment.

An exemplary use of the apparatus may be described in connection with the flowback from an oil and gas well following a chemical stimulation treatment. Typically, the total flowback stream is first routed to gravity separator 10 by appropriate flowlines and piping. The gravity separation unit then separates the overall fluid stream into a predominantly oil stream (which is routed to other equipment for further handling) and a wastewater stream, which is predominantly water but contains some organics. Next, the wastewater stream is routed through flotation unit 30 (described above), which by combination of the flotation process and coalescing media (in the preferred embodiment) removes still further entrained organics. The wastewater stream is next optionally routed through a filter press 20, to remove entrained solids (such as sand, rust, scale and the like). In the preferred embodiment of the method of treatment, sock filters 50 are next disposed in the wastewater flowstream, through which the wastewater is flowed. Cellulose based filter media 60 comprise the next treating means through which the wastewater is flowed. Flowing pressure differential across cellulose based filter media 60 is monitored to determine when the media should be changed out, and as described herein typically a pressure differential of about 10 psi indicates the need for changing the media. Monitoring of the organic component level of the wastewater stream emanating from cellulose based filter media 60 may be done by means well known in the art, to ensure that the effluent is within acceptable regulatory limits, and to aid in determining when to change out the cellulose based filter media. Finally, the wastewater stream may be routed through a polishing unit containing filter media such as activated carbon filter media, 70. If required, monitoring of the final wastewater discharge may be done to ensure regulatory compliance. Final monitoring may include measurement of organic contaminant level (“oil and grease” levels), pH, and other components. The processed wastewater stream, when within applicable regulatory limits on entrained organics, may be disposed of in a suitable means, for example by routing overboard in the case of offshore oil and gas production operations, routing to injection wells, etc. A similar method is followed for treatment of wastewater produced from pipeline operations.

While the above description contains many specificities, it is understood that they are by way of example only and not limitation. Changes can be made to the described embodiment without departing from the spirit of the invention. For example, the sequence of wastewater flow through the various treatment equipment may be altered; and certain components of the overall treatment sequence may be omitted entirely, depending upon the nature of the fluid stream being treated.

Therefore, the scope of the invention is to be measured not by the examples above, but by the appended claims and their legal equivalents.

We claim:

1. A system for enhanced removal of organic particles from wastewater streams flowing from oil and gas wells, said wastewater stream comprising at least a portion of an overall fluid stream flowing from said oil and gas wells, the system comprising:
a) a flotation unit;
b) a cellulose-based, organic adsorptive filter media fluidly coupled to said flotation unit,
where said oil and gas well wastewater stream sequentially flows first through said flotation unit and then through said cellulose-based filter media.

2. The apparatus of claim 1, further comprising a sock-type filter fluidly coupled to said cellulose-based filter media upstream of said cellulose-based filter media.

3. The apparatus of claim 2, further comprising a carbon-element filter disposed in said wastewater stream downstream of said cellulose-based filter media.

4. The apparatus of claim 1, wherein said wastewater stream comprises at least a portion of the fluid stream flowed out of an oil and gas well following chemical stimulation of said oil and gas well.

5. The apparatus of claim 1, wherein said wastewater stream comprises at least a portion of the fluid stream flowed out of an oil and gas well following completion of said oil and gas well.

6. A system for enhanced removal of organic contaminants from wastewater streams generated from transmission pipeline operations, the system comprising:
a) a flotation unit;
b) a cellulose-based, organic adsorptive filter media fluidly coupled to said flotation unit,
where said wastewater stream sequentially flows first through said flotation unit and then through said cellulose-based filter media.

7. The apparatus of claim 6, further comprising a sock-type filter fluidly coupled to said cellulose-based filter media upstream of said cellulose-based filter media.

8. The apparatus of claim 7, further comprising a carbon-element filter disposed in said wastewater stream downstream of said cellulose-based filter media.

9. The apparatus of claim 6, wherein said wastewater stream comprises at least a portion of the fluid stream flowed out of an oil and gas well following chemical stimulation of said oil and gas well.

10. The apparatus of claim 6, wherein said wastewater stream comprises at least a portion of the fluid stream flowed out of an oil and gas well following completion of said oil and gas well.

11. A method for removing organic contaminants from a wastewater stream, said wastewater stream comprising at least a portion of an overall fluid stream flowing from an oil and gas well, comprising the steps of:
a) providing an apparatus comprising:
i) a flotation unit;
ii) a cellulose-based, organic adsorptive filter media fluidly coupled to said flotation unit;
b) fluidly coupling said apparatus to said wastewater stream;
c) flowing said wastewater stream through said apparatus and monitoring an organic content of said wastewater stream discharged from said apparatus, to ensure a discharged organic level within a desired range; and
d) routing said wastewater stream to an ultimate disposal location.
